(19) United States
(12) Patent Application Publication
(10) Pub. No.: US 2016/0028099 A1
(43) Pub. Date: Jan. 28, 2016

(54) ELECTROLYTE MATERIAL, LIQUID COMPOSITION AND MEMBRANE/ELECTRODE ASSEMBLY FOR POLYMER ELECTROLYTE FUEL CELL

(71) Applicant: Asahi Glass Company, Limited, Tokyo (JP)

(72) Inventors: Susumu SAITO, Tokyo (JP); Satoru HOMMURA, Tokyo (JP); Tetsuji SHIMOHIRA, Tokyo (JP)

(73) Assignee: Asahi Glass Company, Limited, Tokyo (JP)

(21) Appl. No.: 14/873,340

(22) Filed: Oct. 2, 2015

Related U.S. Application Data
(63) Continuation of application No. PCT/JP2014/060750, filed on Apr. 15, 2014.

(30) Foreign Application Priority Data
Apr. 22, 2013 (JP) 2013-089797

(51) Int. Cl. H01M 8/10

(52) U.S. Cl. CPC H01M 8/1039; H01M 8/1072; H01M 8/1004; H01M 8/1023; H01M 2300/0082

(57) ABSTRACT

To provide an electrolyte material with which a membrane/electrode assembly in which flooding in a catalyst layer and breakage of a polymer electrolyte membrane are less likely to occur and which is excellent in the power generation characteristics, can be obtained; and a process for producing an electrolyte material having a low water content even though the material is formed of a polymer having units derived from a perfluoromonomer having a dioxolane ring.

An electrolyte membrane which is formed of a polymer (H) obtained by converting —SO₂F groups of a polymer (F) having units derived from a perfluoromonomer having a —SO₂F group and a dioxolane ring, units derived from a perfluoromonomer having no —SO₂F group and having a dioxolane ring, and units derived from tetrafluoroethylene, to ion exchange groups, which has an ion exchange capacity of from 0.9 to 1.3 meq/g dry resin, and which has a water content of from 20 to 100%.

### TECHNICAL FIELD

The present invention relates to an electrolyte material, a liquid composition containing the electrolyte material, and a membrane/electrode assembly for a polymer electrolyte fuel cell, wherein at least one of a catalyst layer and a polymer electrolyte membrane contains the electrolyte material.

### BACKGROUND ART

As an electrolyte material to be contained in a catalyst layer of a membrane/electrode assembly for a polymer electrolyte fuel cell (hereinafter sometimes referred to simply as a membrane/electrode assembly), the following polymer has been proposed.

(1) A polymer obtained by converting —SO₂F groups in a polymer having units derived from a perfluoromonomer having a —SO₂F group and a dioxolane ring, units derived from a perfluoromonomer having no —SO₂F group and having a dioxolane ring, and units derived from tetrafluoroethylene (hereinafter sometimes referred to as TFE), to ion exchange groups (such as —SO₃⁻H⁺ groups) (Patent Document 1).

A membrane/electrode assembly having a catalyst layer containing the polymer (1) is excellent in the power generation characteristics, however, since the polymer (1) has a high water content, flooding is likely to occur under high humidity conditions, and its power generation characteristics are likely to deteriorate.

Further, a polymer electrolyte membrane containing the polymer (1) undergoes significant changes in dimension when it swells as compared with the dimension in a dry state, due to a high water content of the polymer (1). Accordingly, the polymer electrolyte membrane may be broken in some cases when it undergoes repetition of swelling and drying.

### PRIOR ART DOCUMENTS

### Patent Documents

Patent Document 1: WO2011/013577

### DISCLOSURE OF INVENTION

### Technical Problem

The present invention provides an electrolyte material with which a membrane/electrode assembly in which flooding in a catalyst layer and breakage of a polymer electrolyte membrane are less likely to occur and which is excellent in the power generation characteristics, can be obtained; a process for producing an electrolyte material having a low water content even though the material is formed of a polymer having units derived from a perfluoromonomer having a dioxolane ring; a membrane/electrode assembly in which either one or both of flooding in a catalyst layer and breakage of a polymer electrolyte membrane are less likely to occur, and which is excellent in the power generation characteristics when the catalyst layer contains the electrolyte material of the present invention; and a liquid composition suitable for formation of a catalyst layer or a polymer electrolyte membrane.

### Solution to Problem

The present invention provides the following.

(1) An electrolyte material, which is formed of a polymer (H) obtained by converting —SO₂F groups in the following polymer (F) to ion exchange groups, which has an ion exchange capacity of from 0.9 to 1.3 meq/g dry resin, and which has a water content measured by the following method of from 20 to 100%:

### Polymer (F):

a copolymer having at least one type of units (A) selected from the group consisting of units (A1) derived form a compound represented by the following formula (ma1) and units (A2) derived form a compound represented by the following formula (ma2),

at least one type of units (B) selected from the group consisting of units (B1) derived form a compound represented by the following formula (mb1) and units (B2) derived form a compound represented by the following formula (mb2), and

units (C) derived from tetrafluoroethylene, and

having at least one type of units selected from the group consisting of the units (A1) derived from a compound represented by the following formula (ma1) and the units (B1) derived from a compound represented by the following formula (mb1):

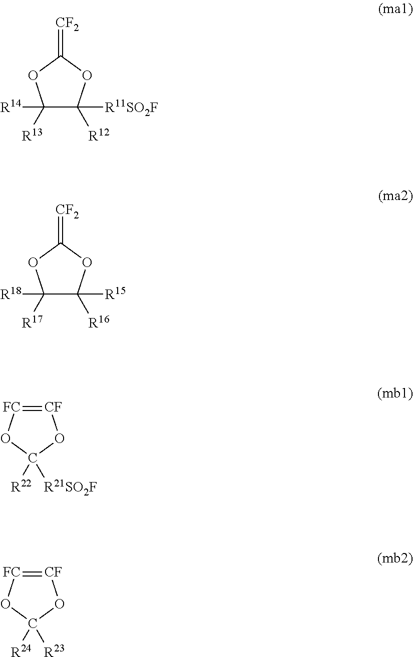

wherein R¹¹ is a C₁₋₁₀ perfluoroalkylene group or a C₂₋₁₀ perfluoroalkylene group having an etheric oxygen atom in a carbon-carbon bond,

each of R¹², R¹³ and R¹⁵ to R¹⁸ which are independent of one another, is a fluorine atom, a C₁₋₁₀ perfluoroalkyl group or a C₂₋₁₀ perfluoroalkyl group having an etheric oxygen atom in a carbon-carbon bond,

R¹⁴ is a fluorine atom, a C₁₋₁₀ perfluoroalkyl group, a C₂₋₁₀ perfluoroalkyl group having an etheric oxygen atom in a carbon-carbon bond, or a —R¹¹SO₂F group,

R²¹ is a C₁₋₁₀ perfluoroalkylene group or a C₂₋₁₀ perfluoroalkylene group having an etheric oxygen atom in a carbon-carbon bond,

R²² is a fluorine atom, a C₁₋₁₀ perfluoroalkyl group, a C₂₋₁₀ perfluoroalkyl group having an etheric oxygen atom in a carbon-carbon bond, or a —R²¹SO₂F group, and

each of R²³ and R²⁴ which are independent of each other, is a fluorine atom, a C₁₋₁₀ perfluoroalkyl group or a C₂₋₁₀ perfluoroalkyl group having an etheric oxygen atom in a carbon-carbon bond:

Method for measuring water content: A film of the polymer (H) is dipped in warm water at 80° C. for 16 hours, the film together with the warm water is cooled to room temperature. The film is taken out from the water, water droplets attached to the surface are wiped off and immediately after wiping, the mass W1 of the film containing water is measured. The film is put in a globe box and left to stand in an atmosphere into which dry nitrogen was blown for 24 hours or longer to dry the film. The dry mass W2 of the film is measured in the globe box. The water content is obtained from the following formula (1):

Water content (%)=(W1−W2)/W2×100 (1)

(2) The electrolyte material according to the above (1), wherein the sum of the units (A) and the units (B) is from 30 to 90 mol % based on all the monomer units (100 mol %).
(3) The electrolyte material according to the above (1) or (2), wherein the compound represented by the formula (ma1) is a compound of the after-mentioned formula (ma1-1), the compound represented by the formula (ma2) is a compound of the after-mentioned formula (ma2-1), the compound represented by the formula (mb1) is a compound of the after-mentioned formula (mb1-1), and the compound represented by the formula (mb2) is a compound of the after-mentioned formula (mb2-1).
(4) The electrolyte material according to any one of the above (1) to (3), wherein the polymer (F) is one obtained by the following method:

Method for producing polymer (F): In a polymerization container, at least one compound (ma) selected from the group consisting of a compound represented by the above formula (ma1) and a compound represented by the above formula (ma2), at least one compound (mb) selected from the group consisting of a compound represented by the above formula (mb1) and a compound represented by the above formula (mb2), and tetrafluoroethylene, are continuously or intermittently supplied over a period of at least 2 hours, particularly from 2 to 15 hours and copolymerized (provided that at least one compound to be supplied to the polymerization container is a compound selected from the group consisting of the compound represented by the formula (ma1) and the compound represented by the formula (mb1).

(5) A process for producing an electrolyte material, which comprises the following steps (a) and (b):

(a) a step of continuously or intermittently supplying to a polymerization container at least one compound (ma) selected from the group consisting of a compound represented by the after-mentioned formula (ma1) and a compound represented by the after-mentioned formula (ma2), at least one compound (mb) selected from the group consisting of a compound represented by the after-mentioned formula (mb1) and a compound represented by the after-mentioned formula (mb2), and tetrafluoroethylene, over a period of at least 2 hours, particularly from 2 to 15 hours to copolymerize them thereby to obtain a polymer (F) having —SO₂F groups (provided that at least one compound to be supplied to the polymerization container is a compound selected from the group consisting of the compound represented by the after-mentioned formula (ma1) and the compound represented by the after-mentioned formula (mb1); and

(b) a step of converting —SO₂F groups in the polymer (F) to ion exchange groups to obtain an electrolyte material formed of a polymer (H) having ion exchange groups.

(6) The process for producing an electrolyte material according to the above (5), wherein the sum of the compound (ma) and the compound (mb) is from 30 to 90 mol % based on all the monomers (100 mol %).
(7) The process for producing an electrolyte material according to the above (5) or (6), wherein the compound represented by the formula (ma1) is a compound of the after-mentioned formula (ma1-1), the compound represented by the formula (mat) is a compound of the after-mentioned formula (ma2-1), the compound represented by the above formula (mb1) is a compound of the after-mentioned formula (mb1-1), and the compound represented by the formula (mb2) is a compound of the after-mentioned formula (mb2-1).
(8) The process for producing an electrolyte material according to any one of the above (5) to (7), wherein the compound (ma) and the compound (mb) are supplied with cooling.
(9) A liquid composition comprising a dispersion medium and the electrolyte material as defined in any one of the above (1) to (4) dispersed in the dispersion medium, wherein the dispersion medium contains an organic solvent having a hydroxy group.
(10) A membrane/electrode assembly for a polymer electrolyte fuel cell, which comprises

an anode having a catalyst layer,

a cathode having a catalyst layer, and

a polymer electrolyte membrane disposed between the anode and the cathode,

wherein at least one of the cathode and the anode contains the electrolyte material as defined in any one of the above (1) to (4).

### Advantageous Effects of Invention

According to the electrolyte material of the present invention, a membrane/electrode assembly in which flooding in a catalyst layer and breakage of a polymer electrolyte membrane are less likely to occur, and which is excellent in the power generation characteristics, can be obtained.

According to the process for producing an electrolyte material of the present invention, an electrolyte material having a low water content, even though it is formed of a polymer having units derived from a perfluoromonomer having a dioxolane ring, can be produced.

In the membrane/electrode assembly of the present invention, either one or both of flooding in a catalyst layer and breakage of a polymer electrolyte membrane are less likely to occur, and the assembly is excellent in the power generation characteristics when the catalyst layer contains the electrolyte material of the present invention.

The liquid composition of the present invention is suitable for formation of a catalyst layer and a polymer electrolyte membrane.

### BRIEF DESCRIPTION OF DRAWINGS

FIG. 1 is a cross-section illustrating one example of a membrane/electrode assembly of the present invention.

FIG. 2 is a cross-section illustrating another example of a membrane/electrode assembly of the present invention.

### DESCRIPTION OF EMBODIMENTS

In this specification, a compound represented by the formula (ma1) will be referred to as a compound (ma1). The same applies to compounds represented by other formulae.

Further, in this specification, a group represented by the formula (g1) will be referred to as a group (g1). The same applies to groups represented by other formulae.

Further, in this specification, a unit represented by the formula (A1′) will be referred to as a unit (A1′). The same applies to units represented by other formulae.

The following definitions of terms apply to this specification and claims.

“A monomer” is a compound having a polymerizable carbon-carbon double bond.

“Units derived from (a monomer)” are structural units composed of molecules of a monomer (such as a compound (ma1)), formed by polymerization of the monomer. The units may be units directly formed by the polymerization reaction, or may be units having part of the units converted to another structure by treating the polymer.

“An ion exchange group” is a group having H⁺, a monovalent metal cation, an ammonium ion or the like.

### <Electrolyte Material>

The electrolyte material of the present invention is formed of a polymer (H) obtained by converting —SO₂F groups of a polymer (F) converted to ion exchange groups.

### (Polymer (F))

The polymer (F) is a copolymer having at least one type of units (A) selected from the group consisting of units (A1) derived from a compound (ma1) and units (A2) derived from a compound (ma2), at least one type of units (B) selected from the group consisting of units (B1) derived from a compound (mb1) and units (B2) derived from a compound (mb2), and units (C) derived from TFE. Further, the polymer (F) has, as either one or both of the units (A) and the units (B), at least one type of units derived from a compound having a —SO₂F group, since the polymer (F) should have —SO₂F groups. That is, the polymer (F) should have at least one type of units selected from the group consisting of the units (A1) derived from a compound (ma1) and the units (B1) derived from a compound (mb1).

The polymer (F) may have units (D) other than the units (A) to (C) within a range not to impair the effects of the present invention.

### Units (A):

The units (A) are at least one type selected from the group consisting of units (A1) derived from a compound (ma1) and units (A2) derived from a compound (ma2). In a case where the polymer (F) has the units (A1), the units (A1) may be one type or two or more types. In a cases where the polymer (F) has the units (A2), the units (A2) may be one type or two or more types.

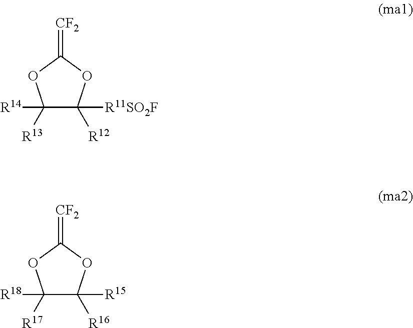

R¹¹ is a C₁₋₁₀ perfluoroalkylene group or a C₂₋₁₀ perfluoroalkylene group having an etheric oxygen atom in a carbon-carbon bond. In a case where the perfluoroalkylene group has an etheric oxygen atom, the number of such an oxygen atom may be one or more. The perfluoroalkylene group may be linear or branched, and is preferably linear.

Each of R¹², R¹³ and R¹⁵ to R¹⁸ which are independent of one another, is a fluorine atom, a C₁₋₁₀ perfluoroalkyl group, or a C₂₋₁₀ perfluoroalkyl group having an etheric oxygen atom in a carbon-carbon bond. In a case where the perfluoroalkyl group has an etheric oxygen atom, the number of such an oxygen atom may be one or more. The perfluoroalkyl group may be linear or branched, and is preferably linear.

R¹⁴ is a fluorine atom, a C₁₋₁₀ perfluoroalkyl group, a C₂₋₁₀ perfluoroalkyl group having an etheric oxygen atom in a carbon-carbon bond, or a —R¹¹SO₂F group. In a case where the perfluoroalkyl group has an etheric oxygen atom, the number of such an oxygen atom may be one or more. The perfluoroalkyl group may be linear or branched, and is preferably linear. In a case where the compound (ma1) has two R¹¹'s, the two R¹¹'s may be the same or different from each other.

The compound (ma1) is preferably compound (ma11) in view of easy preparation and a high polymerization reactivity.

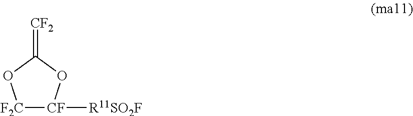

The compound (ma1) may, for example, be any of compounds (ma1-1) to (ma1-4), and is particularly preferably compound (ma1-1) in view of easy preparation and a high polymerization reactivity.

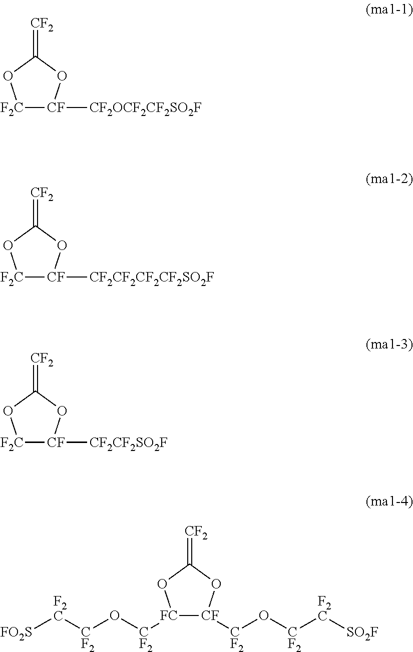

The compound (ma1) may be prepared by a method as disclosed in WO2003/037885, JP-A-2005-314388, JP-A-2009-040909 or the like.

The compound (ma2) is preferably compound (ma21) in view of easy preparation and a high polymerization reactivity.

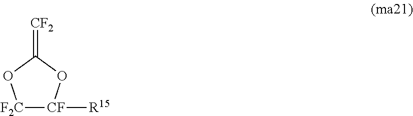

The compound (ma2) may, for example, be compound (ma2-1) or (ma2-2), and is particularly preferably compound (ma2-1) in view of easy preparation and a high polymerization reactivity.

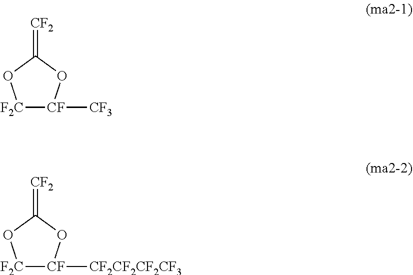

### Units (B):

The units (B) are at least one type selected from the group consisting of units (B1) derived from a compound (mb1) and units (B2) derived from a compound (mb2). In a case where the polymer (F) has the units (B1), the units (B1) may be one type or two or more types. In a case where the polymer (F) has the units (B2), the units (B2) may be one type or two or more types.

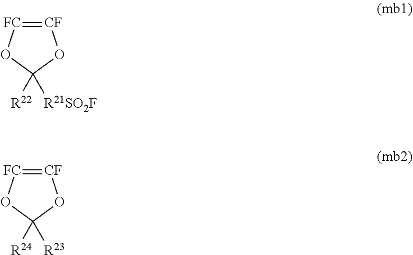

R²¹ is a C₁₋₁₀ perfluoroalkylene group or a C₂₋₁₀ perfluoroalkylene group having an etheric oxygen atom in a carbon-carbon bond. In a case where the perfluoroalkylene group has an etheric oxygen atom, the number of such an oxygen atom may be one or more. The perfluoroalkylene group may be linear or branched, and is preferably linear.

R²² is a fluorine atom, a C₁₋₁₀ perfluoroalkyl group, a C₂₋₁₀ perfluoroalkyl group having an etheric oxygen atom in a carbon-carbon bond, or a —R²¹SO₂F group. In a case where the perfluoroalkyl group has an etheric oxygen atom, the number of such an oxygen atom may be one or more. The perfluoroalkyl group may be linear or branched, and is preferably linear. In a case where the compound (mb1) has two R²¹'s, the two R²¹'s may be the same or different from each other.

Each of R²³ and R²⁴ which are independent of each other, is a fluorine atom, a C₁₋₁₀ perfluoroalkyl group, or a C₂₋₁₀ perfluoroalkyl group having an etheric oxygen atom in a carbon-carbon bond. In a case where the perfluoroalkyl group has an etheric oxygen atom, the number of such an oxygen atom may be one or more. The perfluoroalkyl group may be linear or branched, and is preferably linear.

The compound (mb1) may, for example, be compound (mb1-1) or (mb1-2).

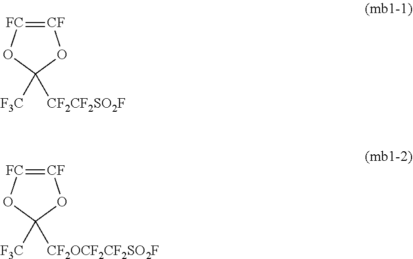

The compound (mb1) may be prepared by a method as disclosed in JP-A-2006-152249 or the like.

The compound (mb2) may, for example, be any of compounds (mb2-1) to (mb2-6), and is particularly preferably compound (mb2-1) in view of a high effect to improve the electrode performance of the polymer.

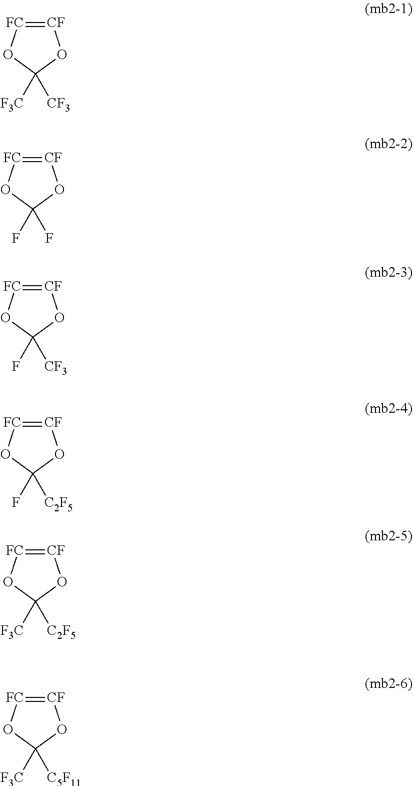

The compound (mb2) may be prepared by a method as disclosed in Macromolecule, vol. 26, No. 22, 1993, p. 5829 to 5834 or JP-A-6-92957.

### Units (C):

The units (C) are units derived from TFE. Since a polymer having units derived from TFE has high crystallinity, the units (C) have an effect to suppress swelling when the polymer (H) contains water, and can reduce the water content of the polymer (H).

### Other Units (D):

Other units (D) are units derived from a monomer other than the compound (ma), the compound (mb) and TFE (hereinafter sometimes referred to as compound (md)).

The compound (md) may, for example, be chlorotrifluoroethylene, trifluoroethylene, vinylidene fluoride, vinyl fluoride, ethylene, propylene, perfluoro(3-butenyl vinyl ether), perfluoro(allyl vinyl ether), a perfluoro α-olefin (such as hexafluoropropylene), a (perfluoroalkyl)ethylene (such as (perfluorobutyl)ethylene), a (perfluoroalkyl)propene (such as 3-perfluorooctyl-1-propene), or a perfluoro(alkyl vinyl ether). Further, as the compound (md), a perfluoromonomer having two or more carbon-carbon double bonds having polymerizability, may be used.

### Composition of Units:

The sum of the units (A) and the units (B) is preferably from 30 to 90 mol %, more preferably from 40 to 90 mol % based on all the monomer units (100 mol %). When the sum of the units (A) and the units (B) is at least 30 mol %, the gas permeability of a catalyst layer containing the polymer (H) will be favorable. When the sum of the units (A) and the units (B) is at most 90 mol %, the water content of the polymer (H) will be further lower.

### (Polymer (H))

The polymer (H) is a polymer obtained by converting —SO₂F groups in the polymer (F) to ion exchange groups.

The polymer (H) has at least one type of units (A′) selected from the group consisting of units (A1′) obtained by converting a —SO₂F group in the units (A1) to an ion exchange group and the units (A2), at least one type of units (B′) selected from the group consisting of units (B1′) obtained by converting a —SO₂F group in units (B1) to an ion exchange group and the units (B2), and the units (C). The polymer (H) may have other units (D) within a range not to impair the effects of the present invention.

Further, the polymer (H) has at least one type of units each having an ion exchange group as either one or both of the units (A′) and the units (B′) since the polymer (H) should have ion exchange groups. That is, the polymer (H) should have at least one type of units selected from the group consisting of the units (A1′) and the units (B1′).

### Ion Exchange Group:

The ion exchange group is preferably group (g1).

—(SO₂X(SO₂R^{f})ₐ)⁻M⁺ (g1)

M⁺ is H⁺, a monovalent metal cation, or an ammonium ion in which at least one hydrogen atom may be substituted with a hydrocarbon group, and is preferably H⁺ in view of high electrical conductivity.

R^{f} is a linear or branched perfluoroalkyl group which may have an etheric oxygen atom. The number of carbon atoms in the perfluoroalkyl group is preferably from 1 to 8, more preferably from 1 to 6. In a case where the group (g1) has two or more R^{f}'s, the R^{f}'s may be the same or different from each other.

X is an oxygen atom, a nitrogen atom or a carbon atom, and a=0 when X is an oxygen atom, a=1 when X is a nitrogen atom, and a=2 when X is a carbon atom.

The group (g1) may be a sulfonate group (a —SO₃⁻M⁺ group), a sulfonimide group (a —SO₂N(SO₂R^{f})⁻M⁺ group) or a sulfonmethide group (a —SO₂C(SO₂R^{f})₂)⁻M⁺ group).

### Units (A′):

The units (A′) are at least one member selected from the group consisting of the units (A1′) and the units (A2). In a case where the polymer (H) has the units (A1′), the units (A1′) may be one type or two or more types. In a case where the polymer (H) has units (A2), the units (A2) may be one type or two or more types.

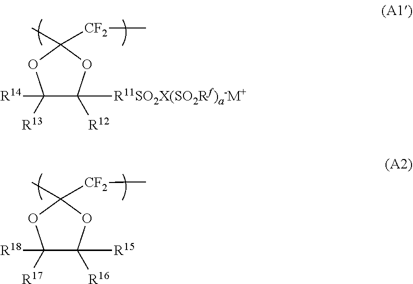

### Units (B′):

The units (B′) are at least one member selected from the group consisting of the units (B1′) and units (B2). In a case where the polymer (H) has units (B1′), the units (B1′) may be one type or two or more types. In a case where the polymer (H) has units (B2), the units (B2) may be one type or two or more types.

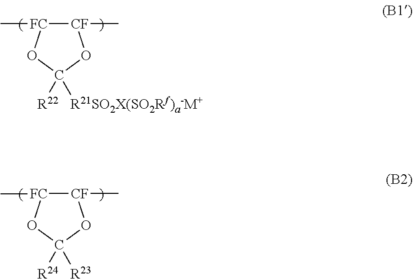

### Ion Exchange Capacity:

The ion exchange capacity of the polymer (H) is from 0.9 to 1.3 meq/g dry resin, preferably from 1.0 to 1.25 meq/g dry resin. When the ion exchange capacity is at least 0.9 meq/g dry resin, the polymer (H) has high electrical conductivity and accordingly when it is used as an electrolyte material for a catalyst layer or a polymer electrolyte membrane of a polymer electrolyte fuel cell, sufficient cell output will be obtained. When the ion exchange capacity is at most 1.3 meq/g dry resin, an increase of the water content of the polymer (H) will be suppressed.

In order to adjust the ion exchange capacity of the polymer (H) to be within the above range, the proportion of the compound (ma1) and the compound (mb1) at the time of preparing the polymer (F) is adjusted. Specifically, it is important to control the monomer composition at the time of polymerization, and for that purpose, it is necessary to determine the charge composition considering the polymerizability of monomers.

### Water Content:

The water content of the polymer (H) is from 20 to 100%, preferably from 30 to 90%. When the water content is at least 20%, sufficient proton conductivity is achieved even at the time of operation under low humidity conditions. When the water content is at most 100%, flooding in a catalyst layer and breakage of a polymer electrolyte membrane are less likely to occur. When the water content is at least 30%, the polymer is easily produced.

In order to adjust the water content of the polymer (H) to be within the above range, as described hereinafter, at the time of preparing the polymer (F), it is preferred to continuously or intermittently supply to a polymerization container at least one compound (ma) selected from the group consisting of the compound (ma1) and the compound (ma2), at least one compound (mb) selected from the group consisting of the compound (mb1) and the compound (mb2), and TFE, over a period of from 2 to 15 hours to copolymerize them (provided that at least one compound to be supplied to the polymerization container is a compound selected from the group consisting of the compound (ma1) and the compound (mb1)). By continuously or intermittently supplying the respective monomers, a polymer (F) with a small dispersion of the composition of the units among the molecular chains can be obtained, and the water content of the polymer (H) is suppressed to be low.

### Advantageous Effects

The above-described electrolyte material of the present invention is formed of the polymer (H) obtained by converting —SO₂F groups of the polymer (F) having the units (A), the units (B) and the units (C) converted to ion exchange groups, and has an ion exchange capacity of at least 0.9 meq/g dry resin, and accordingly a membrane/electrode assembly having a catalyst layer containing the electrolyte material has sufficient power generation characteristics (such as output voltage).

Further, it has a water content of from 20 to 100% and an ion exchange capacity of at most 1.3 meq/g dry resin, and accordingly flooding in the catalyst layer containing the electrolyte material and breakage of a polymer electrolyte membrane containing the electrolyte material are less likely to occur.

### <Process for Producing Electrolyte Material>

The process for producing an electrolyte material of the present invention comprises the following steps (a) and (b).

(a) A step of continuously or intermittently supplying to a polymerization container at least one compound (ma) selected from the group consisting of the compound (ma1) and the compound (ma2), at least one compound (mb) selected from the group consisting of the compound (mb1) and the compound (mb2), and TFE, over a period of from 2 to 15 hours to copolymerize them thereby to obtain a polymer (F) having —SO₂F groups (provided that at least one compound to be supplied to the polymerization container is a compound selected from the group consisting of the compound (ma1) and the compound (mb1)).

(b) A step of converting —SO₂F groups in the polymer (F) to ion exchange groups to obtain an electrolyte material formed of a polymer (H) having ion exchange groups.

### (Step (a))

The polymer (F) is produced by polymerizing the compound (ma), the compound (mb) and TFE and as the case requires, the compound (md).

The present invention is characterized by continuously or intermittently supplying the compound (ma), the compound (mb) and TFE, and as the case requires, the compound (md) over a period of at least 2 hours, particularly from 2 to 15 hours, to copolymerize them. The compound (ma), the compound (mb) and TFE and as the case requires, the compound (md) are preferably supplied continuously or intermittently over a period of from 2 to 12 hours.

TFE, which is a gas, is usually supplied separately from the compound (ma), the compound (mb) and the compound (md).

The compound (ma), the compound (mb) and the compound (md) may be supplied as mixed or separately.

When two or more types of the compounds (ma) are used, all the compounds (ma) may be supplied as mixed, part of the compounds (ma) may be mixed and the rest of the compounds (ma) are separately supplied, or all the compounds (ma) may be separately supplied.

When two or more types of the compounds (mb) are used, all the compounds (mb) may be supplied as mixed, part of the compounds (mb) may be mixed and the rest of the compounds (mb) are separately supplied, or all the compounds (mb) may be separately supplied.

When two or more types of the compounds (md) are used, all the compounds (md) may be supplied as mixed, part of the compounds (md) may be mixed and the rest of the compounds (md) are separately supplied, or all the compounds (md) may be separately supplied.

All the compound (ma), the compound (mb), TFE and the compound (md) may be continuously supplied, part of them may be continuously supplied and the rest is intermittently supplied, or all of them may be intermittently supplied. Part of the monomers excluding TFE may preliminarily be charged to the polymerization container.

In a case where they are intermittently supplied, all the monomers to be intermittently supplied may be supplied at the same timing, part of the monomers to be intermittently supplied may be supplied at the same timing and the rest of the monomers is supplied at a separate timing, or all the monomers to be intermittently supplied may be supplied at separate timings. It is preferred that all the monomers to be intermittently supplied are supplied at the same timing, whereby a polymer (F) with a small dispersion of the composition of units among the molecular chains will be obtained.

In a case where they are intermittently supplied, the number of times of supply is preferably at least 3, more preferably at least 4, whereby a polymer (F) with a small dispersion of the composition of units among the molecular chains will be obtained. The number of times of supply is preferably at most 20 in view of the productivity.

It is ideal to continuously supply the compound (ma), the compound (mb) and TFE and as the case requires the compound (md) at a constant supply rate over a period of from 2 to 15 hours, whereby a polymer (F) with a small dispersion of the composition of units among the molecular chains will be obtained.

The compounds (ma) and the compounds (mb) may be polymerized e.g. in a supply line before they are supplied to the polymerization container. Accordingly, in the process for producing an electrolyte material of the present invention, it is preferred to supply the compound (ma) and the compound (mb) while they are cooled at least in the supply line. The cooling temperature in the supply line is preferably from 0 to −100° C., and it is more preferred to cool the supply line with dry ice.

The sum of the compound (ma) and the compound (mb) is preferably from 30 to 90 mol % based on all the monomers (100 mol %). When the sum of the compound (ma) and the compound (mb) is at least 30 mol %, the gas permeability of a catalyst layer containing the polymer (H) will be favorable. When the sum of the compound (ma) and the compound (mb) is at most 90 mol %, the water content of the polymer (H) will be further lower.

As the polymerization method, a known polymerization method may be mentioned such as a bulk polymerization method, a solution polymerization method, a suspension polymerization method or an emulsion polymerization method. Otherwise, polymerization may be carried out in liquid or supercritical carbon dioxide.

The polymerization is carried out under a condition to form radicals. The method to form radicals may, for example, be a method of applying a radiation such as ultraviolet rays, γ-rays or electron beams, or a method of adding a radical polymerization initiator.

The polymerization temperature (temperature in the polymerization container) is usually from 10 to 150° C.

The radical polymerization initiator may, for example, be a bis(fluoroacyl)peroxide, a bis(chlorofluoroacyl)peroxide, a dialkyl peroxy dicarbonate, a diacyl peroxide, a peroxy ester, an azo compound or a persulfate, and a perfluoro compound such as a bis(fluoroacyl)peroxide is preferred from such a viewpoint that the polymer (F) substantially free from unstable terminal groups is thereby obtainable.

A solvent to be used for the solution polymerization method is preferably a solvent having a boiling point of from 20 to 350° C., more preferably a solvent having a boiling point of from 40 to 150° C. Such a solvent may, for example, be a perfluorotrialkylamine (such as perfluorotributylamine), a perfluorocarbon (such as perfluorohexane or perfluorooctane), a hydrofluorocarbon (such as 1H,4H-perfluorobutane or 1H-perfluorohexane), a hydrochlorofluorocarbon (such as 3,3-dichloro-1,1,1,2,2-pentafluoropropane or 1,3-dichloro-1,1,2,2,3-pentafluoropropane) or a hydrofluoroether (such as CF₃CH₂OCF₂CF₂H).

In the solution polymerization method, monomers, a radical polymerization initiator, etc. are added to the solvent to let radicals form in the solvent thereby to carry out polymerization of the monomers. The radical polymerization initiator may be added all at once, sequentially or continuously.

In the suspension polymerization method, water is used as a dispersion medium, and in the dispersion medium, monomers, a non-ionic radical initiator, etc. are added to let radicals form in the dispersion medium thereby to carry out polymerization of the monomers.

The non-ionic radical initiator may, for example, be a bis(fluoroacyl) peroxide, a bis(chlorofluoroacyl) peroxide, a dialkylperoxy dicarbonate, a diacyl peroxide, a peroxy ester, a dialkyl peroxide, a bis(fluoroalkyl) peroxide or an azo compound.

To the dispersion medium, the above-mentioned solvent as an assisting agent; a surfactant as a dispersion stabilizer to prevent agglomeration of suspended particles; a hydrocarbon compound (such as hexane or methanol) as a molecular-weight controlling agent, etc., may be added.

### (Step (b))

The polymer (H) is produced by converting —SO₂F groups in the polymer (F) to ion exchange groups.

As a method of converting —SO₂F groups to sulfonic acid groups (—SO₃⁻H⁺ groups), the following method (i) may be mentioned, and as a method of converting —SO₂F groups to sulfonimide groups (—SO₂N(SO₂R^{f})⁻H⁺ groups), the following method (ii) may be mentioned.

(i) A method of hydrolyzing —SO₂F groups in the polymer (F) to a sulfonate salt and then converting the sulfonate salt to acid-form to obtain sulfonic acid groups.

(ii) A method of imidizing —SO₂F groups in the polymer (F) to salt-form sulfonimide groups, followed by conversion to acid-form to form acid-form sulfonimide groups.

### Method (i):

The hydrolysis is carried out, for example, by contacting the polymer (F) with a basic compound in a solvent. The basic compound may, for example, be sodium hydroxide or potassium hydroxide. The solvent may, for example, be water or a mixed solvent of water with a polar solvent. The polar solvent may, for example, be an alcohol (such as methanol or ethanol) or dimethylsulfoxide.

The conversion to acid-form may be carried out, for example, by contacting the polymer having a sulfonate salt with an aqueous solution of hydrochloric acid, sulfuric acid or the like.

The hydrolysis and conversion to acid-form are carried out usually at a temperature of from 0 to 120° C.

### Method (ii):

As the imidation, the following methods may, for example, be mentioned.

(ii-1) A method of reacting —SO₂F groups with R^{f}SO₂NHM.

(ii-2) A method of reacting —SO₂F groups with R^{f}SO₂NH₂ in the presence of an alkali metal hydroxide, an alkali metal carbonate, MF, ammonia or a primary to tertiary amine.

(ii-3) A method of reacting —SO₂F groups with R^{f}SO₂NMSi(CH₃)₃.

Here, M is an alkali metal or a primary to quaternary ammonium.

The conversion to acid-form is carried out by treating the polymer having salt-form sulfonimide groups with an acid (such as sulfuric acid, nitric acid or hydrochloric acid).

### Advantageous Effects

In the above-described process for producing an electrolyte material of the present invention, at least one compound (ma) selected from the group consisting of the compound (ma1) and the compound (ma2), at least one compound (mb) selected from the group consisting of the compound (mb1) and the compound (mb2), and TFE, are continuously or intermittently supplied over a period of from 2 to 15 hours and copolymerized to obtain a polymer (F) having —SO₂F groups, whereby a polymer (F) with a small dispersion of the composition of units among the molecular chains is obtained, and the water content of the polymer (H) is suppressed.

Whereas in Patent Document 1, a perfluoromonomer having a —SO₂F group and a dioxolane ring, a perfluoromonomer having no —SO₂F group and having a dioxolane ring, and TFE, are charged all at once to a polymerization container and copolymerized to obtain a polymer (F) having —SO₂F groups. Thus, a polymer (F) in which units derived from the perfluoromonomer having a —SO₂F group and a dioxolane ring are unevenly present in part of molecular chains, is obtained, and the water content of the polymer (H) is high as disclosed in Comparative Examples (Ex. 6 and 7).

### <Liquid Composition>

The liquid composition of the present invention is a composition comprising a dispersion medium and the electrolyte material of the present invention dispersed in the dispersion medium.

The dispersion medium contains an organic solvent having a hydroxy group.

The organic solvent having a hydroxy group may, for example, be methanol, ethanol, 1-propanol, 2-propanol, 2,2,2-trifluoroethanol, 2,2,3,3,3-pentafluoro-1-propanol, 2,2,3,3,-tetrafluoro-1-propanol, 4,4,5,5,5-pentafluoro-1-pentanol, 1,1,1,3,3,3-hexafluoro-2-propanol, 3,3,3-trifluoro-1-propanol, 3,3,4,4,5,5,6,6,6-nonafluoro-1-hexanol, or 3,3,4,4,5,5,6,6,7,7,8,8,8-tridecafluoro-1-octanol.

As the organic solvent having a hydroxy group, one type may be used alone, or two or more types may be used as mixed.

The dispersion medium preferably contains water.

The proportion of water is preferably from 10 to 99 mass %, more preferably from 40 to 99 mass %, in the dispersion medium (100 mass %). Dispersibility of the electrolyte material in the dispersion medium can be improved by increasing the proportion of water.

The proportion of the organic solvent having a hydroxy group is preferably from 1 to 90 mass %, more preferably from 1 to 60 mass %, in the dispersion medium (100 mass %).

The proportion of the electrolyte material is preferably from 1 to 50 mass %, more preferably from 3 to 30 mass %, in the liquid composition (100 mass %).

A method of preparing the liquid composition may be a method of applying shearing to the electrolyte material in the dispersion medium under atmospheric pressure or in a sealed state in an autoclave or the like. The preparation temperature is preferably from 0 to 250° C., more preferably from 20 to 150° C. As the case requires, shearing such as ultrasonic waves may be applied.

The liquid composition of the present invention is suitably used for formation of a catalyst layer of a membrane/electrode assembly as described hereinafter.

### <Membrane/Electrode Assembly>

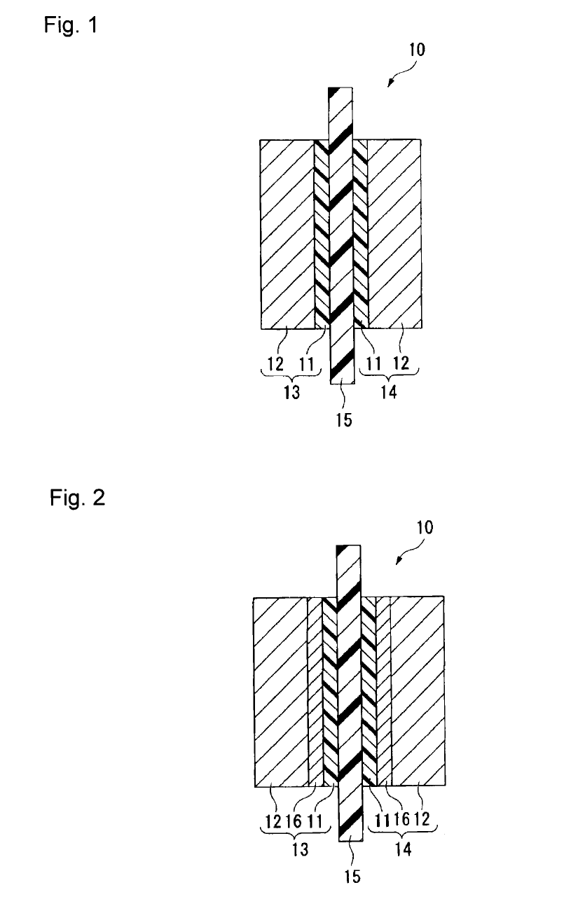

FIG. 1 is a cross section illustrating one example of a membrane/electrode assembly of the present invention. A membrane/electrode assembly 10 comprises an anode 13 having a catalyst layer 11 and a gas diffusion layer 12, a cathode 14 having a catalyst layer 11 and a gas diffusion layer 12, and a polymer electrolyte membrane 15 disposed between the anode 13 and the cathode 14 in a state where it is in contact with the catalyst layers 11.

### (Catalyst Layer)

The catalyst layer 11 is a layer containing a catalyst and a proton conductive polymer.

The catalyst may be a supported catalyst having platinum or a platinum alloy supported on a carbon carrier.

The carbon carrier may, for example, be a carbon black powder.

The proton conductive polymer may be the electrolyte material of the present invention or a known electrolyte material. The proton conductive polymer contained in the catalyst layer of at least one of the cathode and the anode is the electrolyte material of the present invention, and it is preferred that the proton conductive polymer contained in the catalyst layer of the cathode is the electrolyte material of the present invention.

The catalyst layer 11 may contain a water-repellent agent with a view to increasing the effect to suppress flooding. The water-repellent agent may, for example, be a tetrafluoroethylene/hexafluoropropylene copolymer, a tetrafluoroethylene/perfluoro(alkyl vinyl ether) copolymer or polytetrafluoroethylene. The water-repellent agent is preferably a fluoropolymer soluble in a solvent, from such a viewpoint that the water repellent treatment of the catalyst layer 11 is easy. The amount of the water-repellent agent is preferably from 0.01 to 30 mass % in the catalyst layer (100 mass %).

As a method of forming the catalyst layer 11, the following methods may be mentioned.

(i) A method of applying a fluid for forming a catalyst layer on the polymer electrolyte membrane 15, the gas diffusion layer 12 or a carbon layer 16, followed by drying.

(ii) A method of applying a fluid for forming a catalyst layer on a substrate film, followed by drying to form a catalyst layer 11, and transferring the catalyst layer 11 to the polymer electrolyte membrane 15.

The fluid for forming a catalyst layer is a fluid comprising the electrolyte material and the catalyst dispersed in a dispersion medium. The fluid for forming a catalyst layer may be prepared, for example, by mixing the liquid composition of the present invention with a dispersion of the catalyst.

### (Gas Diffusion Layer)

The gas diffusion layer 12 has a function to uniformly diffuse a gas into the catalyst layer 11 and a function as a current collector.

The gas diffusion layer 12 may, for example, be carbon paper, carbon cloth or carbon felt.

The gas diffusion layer 12 is preferably subjected to water repellent treatment e.g. with polytetrafluoroethylene.

### (Carbon Layer)

The membrane/electrode assembly 10 may have a carbon layer 16 between the catalyst layer 11 and the gas diffusion layer 12 as shown in FIG. 2. By disposing the carbon layer 16, the gas diffusion properties on the surface of the catalyst layer 11 will be improved, and the power generation performance of the polymer electrolyte fuel cell will be remarkably improved.

The carbon layer 16 is a layer containing carbon and a nonionic fluorinated polymer.

As the carbon, carbon nanofibers having a fiber diameter of from 1 to 1,000 nm and a fiber length of at most 1,000 μm are preferred.

The nonionic fluorinated polymer may, for example, be polytetrafluoroethylene.

### (Polymer Electrolyte Membrane)

The polymer electrolyte membrane 15 is a membrane containing a proton conductive polymer.

The proton conductive polymer may be the electrolyte material of the present invention or a known electrolyte material.

The polymer electrolyte membrane 15 can be formed, for example, by a method (a casting method) wherein a liquid composition of the electrolyte material is applied on a substrate film or the catalyst layer 11, followed by drying.

The liquid composition is a dispersion having the electrolyte material dispersed in a dispersion medium containing an organic solvent having a hydroxy group.

In order to stabilize the polymer electrolyte membrane 15, it is preferred to carry out heat treatment. The temperature for the heat treatment is preferably from 130 to 200° C. although it depends also on the type of the electrolyte material. When the temperature for the heat treatment is at least 130° C., the electrolyte material will not excessively contain water. When the temperature for the heat treatment is at most 200° C., heat decomposition of ion exchange groups may be suppressed, and a decrease in the proton conductivity of the polymer electrolyte membrane 15 may be suppressed.

The polymer electrolyte membrane 15 may be treated with an aqueous hydrogen peroxide solution as the case requires.

The polymer electrolyte membrane 15 may be reinforced by a reinforcing material. The reinforcing material may, for example, be a porous body, fibers, woven fabric or nonwoven fabric. The material for the reinforcing material may, for example, be polytetrafluoroethylene, a tetrafluoroethylene/hexafluoropropylene copolymer, a tetrafluoroethylene/perfluoro(alkyl vinyl ether) copolymer, polyethylene, polypropylene or polyphenylene sulfide.

The polymer electrolyte membrane 15 may contain at least one type of atoms selected from the group consisting of cerium and manganese in order to further improve the durability. Cerium and manganese will decompose hydrogen peroxide which is a substance to cause deterioration of the polymer electrolyte membrane 15. Such cerium or manganese is preferably present in the form of ions in the polymer electrolyte membrane 15, and so long as it is present in the form of ions, it may be present in any state in the polymer electrolyte membrane 15.

The polymer electrolyte membrane 15 may contain silica or a hetero polyacid (such as zirconium phosphate, phosphorus molybdic acid or phosphorus tungstic acid) as a water retention agent to prevent drying.

### (Process for Producing Membrane/Electrode Assembly)

The membrane/electrode assembly 10 is produced, for example, by the following method.

(i) A method of forming catalyst layers 11 on a polymer electrolyte membrane 15 to form a membrane/catalyst layer assembly, and sandwiching such a membrane/catalyst layer assembly between gas diffusion layers 12.

(ii) A method of forming a catalyst layer 11 on a gas diffusion layer 12 to form electrodes (anode 13 and cathode 14), and sandwiching a polymer electrolyte membrane 15 between such electrodes.

In a case where the membrane/electrode assembly 10 has a carbon layer 16, the membrane/electrode assembly 10 is produced, for example, by the following method.

(i) A method of applying a dispersion containing carbon and a nonionic fluoropolymer on a substrate film, followed by drying to form a carbon layer 16, forming a catalyst layer 11 on the carbon layer 16, bonding such catalyst layers 11 to a polymer electrolyte membrane 15, separating the substrate films to form a membrane/catalyst layer assembly having the carbon layers 16, and sandwiching such a membrane/catalyst layer assembly between gas diffusion layers 12.

(ii) A method of applying a dispersion containing carbon and a nonionic fluoropolymer on a gas diffusion layer 12, followed by drying to form a carbon layer 16, and sandwiching a membrane/catalyst layer assembly having catalyst layers 11 formed on a polymer electrolyte membrane 15 between the gas diffusion layers 12 each having the carbon layer 16.

### Advantageous Effects

In the above-described membrane/electrode assembly 10, when the catalyst layer 11 contains the electrolyte material of the present invention, flooding in the catalyst layer 11 is less likely to occur, and when the polymer electrolyte membrane 15 contains the electrolyte material of the present invention, breakage of the polymer electrolyte membrane 15 is less likely to occur. Further, when the catalyst layer 11 contains the electrolyte material of the present invention, excellent power generation characteristics will be obtained.

### <Polymer Electrolyte Fuel Cell>

The membrane/electrode assembly of the present invention is used for a polymer electrolyte fuel cell. A polymer electrolyte fuel cell is produced, for example, by sandwiching a membrane/electrode assembly between two separators to form a cell, and stacking a plurality of such cells.

As a separator, an electrically conductive carbon plate having grooves formed to constitute flow paths for a fuel gas or an oxidant gas containing oxygen (such as air or oxygen) may, for example, be mentioned.

As a type of the polymer electrolyte fuel cell, a hydrogen/oxygen type fuel cell or a direct methanol type fuel cell (DMFC) may, for example, be mentioned. Methanol or a methanol aqueous solution to be used as a fuel for DMFC may be a liquid feed or a gas feed.

### EXAMPLES

Now, the present invention will be described in detail with reference to Examples. However, it should be understood that the present invention is by no means restricted to such specific Examples. Ex. 1 to 4 are Examples of the present invention, and Ex. 5 to 9 are Comparative Examples.

### (Composition of Units)

The ratio of the units constituting the polymer (F) was obtained from composition analysis by ¹⁹F-NMR.

### (Ion Exchange Capacity)

The ion exchange capacity of the polymer (H) was calculated from the ratio of the units constituting the polymer (F).

### (TQ)

TQ (unit: ° C.) is an index for the molecular weight and the softening temperature of the polymer (F) and is a temperature at which the melt volume weight becomes 100 mm³/sec, when the polymer (F) is subjected to melt-extrusion under an extrusion pressure of 2.94 MPa from a nozzle having a length of 1 mm and an inner diameter of 1 mm.

Using Flow Tester CFT-500D (manufactured by Shimadzu Corporation), the melt volume rate of the polymer (F) was measured by changing the temperature, whereby TQ at which the melt volume rate became 100 mm³/sec was obtained.

### (Water Content)

The water content of the polymer (H) was obtained by the following method.

The polymer (F) was heated to a temperature at which the polymer (F) flowed, and then subjected to press molding to obtain a film having a thickness of from 100 to 200 μm. The film was dipped in an aqueous solution containing 30 mass % of dimethylsulfoxide and 15 mass % of potassium hydroxide at 80° C. for 16 hours to hydrolyze and convert —SO₂F groups in the polymer (F) in the film to —SO₃K groups. The film was dipped in a 3 mol/L hydrochloric acid aqueous solution for 2 hours. The hydrochloric acid aqueous solution was changed, and the same treatment was further carried out four times to convert the —SO₃K groups in the polymer in the film to sulfonic acid groups. The film was sufficiently washed with ultrapure water to obtain a film of the polymer (H).

The film was dipped in warm water at 80° C. for 16 hours, and the film together with warm water was cooled to room temperature. The film was taken out from the water, water droplets attached to the surface were wiped off and immediately after wiping, the mass W1 of the film containing water was measured. The film was put in a globe box and left to stand in an atmosphere into which dry nitrogen was brown for 24 hours or longer to dry the film. The dry mass W2 of the film was measured in the globe box.

The water content was obtained from the following formula (1):

Water content (%)=(W1−W2)/W2×100 (1)

### (Power Generation Characteristics)

While the temperature of the membrane/electrode assembly was maintained at 60° C., hydrogen (utilization ratio: 50%) is supplied to the anode and air (utilization ratio: 50%) is supplied to the cathode, under a pressure of 175 kPa (absolute pressure). Hydrogen and air are supplied under a relative humidity of 100% RH, and the cell voltage when the current density is 1.25 A/cm² is recorded. A case with a cell voltage of at least 0.5V is evaluated as ◯, and a case where it is less than 0.5V is evaluated as X.

(Compound (ma1))

Compound (ma1-1) was prepared in accordance with the method as disclosed in Examples in WO2003/037885, pages 37 to 42.

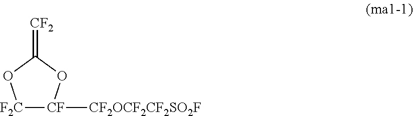

(Compound (ma2))

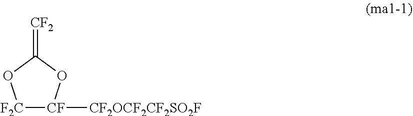

(Compound (mb1))

Compound (mb1-1) was prepared in accordance with the method as disclosed in Examples in Japanese patent No. 4788267, pages 18 to 19.

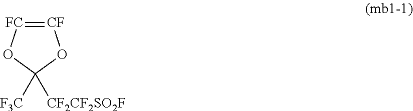

(Compound (mb2))

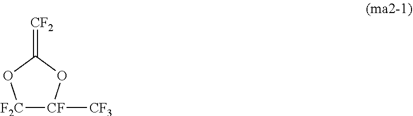

### (Radical Polymerization Initiator)

((CH₃)₂CHOCOO)₂ (i-1)

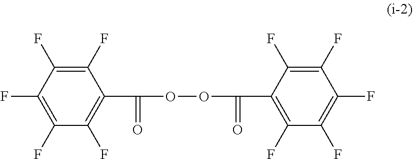 [SMILES: O=C(OOC(=O)c1c(F)c(F)c(F)c(F)c1F)c1c(F)c(F)c(F)c(F)c1F]

### (Solvent)

CCIF₂CF₂CHCIF (s-1)

### (Ex. 1)

Into a stainless steel autoclave having an internal capacity of 125 mL, 22.47 g of compound (mb2-1), 5.10 g of compound (ma1-1), 21.10 g of compound (s-1) as a solvent and 14.7 mg of compound (i-1) as a radical polymerization initiator were charged, followed by sufficient deaeration under cooling with liquid nitrogen. The temperature was raised to 40° C., TFE was continuously supplied under a pressure of 0.40 MPaG at constant temperature and pressure. Every time 0.16 g of TFE was supplied, a mixture of 0.96 g of compound (mb2-1) and 1.0 g of compound (ma1-1) was supplied from a supply line cooled with dry ice. Further, every time the mixture was supplied, the supply line was washed with 0.5 g of compound (s-1). The mixture was supplied totally 12 times. The interval between supplies of the mixture was about 30 minutes. 6.5 hours after initiation of supply of TFE, the autoclave was cooled to terminate the reaction since the TFE supply amount reached a predetermined amount.

The formed product was diluted with compound (s-1), n-hexane was added thereto to agglomerate a polymer, followed by filtration. The polymer was stirred in compound (s-1) and re-agglomerated with n-hexane, followed by filtration. The polymer was dried under reduced pressure overnight at 80° C. to obtain 12.3 g of polymer (F-1). The ratio of units in polymer (F-1) was compound (mb2-1):compound (ma1-1):TFE=52:31:17 (mol %), and the ion exchange capacity of polymer (H-1) calculated from the ratio was 1.13 meq/g dry resin. TQ of polymer (F-1) was 289° C.

Polymer (F-1) was dipped in an aqueous solution containing 20 mass % of methanol and 15 mass % of potassium hydroxide at 50° C. for 40 hours to hydrolyze and convert —SO₂F groups in polymer (F-1) to —SO₃K groups. Then, the polymer was dipped in a 3 mol/L hydrochloric acid aqueous solution at room temperature for 2 hours. The hydrochloric acid aqueous solution was changed, and the same treatment was further carried out four times to obtain polymer (H-1) formed by conversion of the —SO₃K groups to sulfonic acid groups. Polymer (H-1) was sufficiently washed with ultrapure water. The water content of polymer (H-1) was 35%. The results are shown in Table 1.

To polymer (H-1), a mixed solvent of ethanol and water (ethanol/water=60/40 mass ratio) was added to adjust a solid content concentration to 15 mass %, followed by stirring using an autoclave at 105° C. for 8 hours to obtain liquid composition (D-1) having polymer (H-1) dispersed in a dispersion medium.

39 g of water was added to 10 g of a supported catalyst having 50 mass % of platinum supported on a carbon powder, followed by irradiation with ultrasonic waves for 10 minutes to obtain a dispersion of the catalyst. To the dispersion of the catalyst, 60 g of liquid composition (D-1) is added, and 64 g of ethanol is further added to adjust the solid content concentration to 8 mass % to obtain a fluid for forming a catalyst layer. The fluid is applied on a separately prepared sheet made of a copolymer of ethylene and tetrafluoroethylene (tradename: AFLEX 100N, manufactured by Asahi Glass Co., Ltd., thickness: 100 μm) (hereinafter referred to as ETFE sheet) and dried at 80° C. for 30 minutes and further subjected to heat treatment at 165° C. for 30 minutes to form a catalyst layer having an amount of platinum of 0.2 mg/cm².

Between two such catalyst layers, a Flemion membrane (ion exchange capacity: 1.1 meq/g dry resin, thickness: 20 μm, manufactured by Asahi Glass Co., Ltd.) as a polymer electrolyte membrane is sandwiched and heat pressed at a pressing temperature of 160° C. for a pressing time of 5 minutes under a pressure of 3 MPa to bond the catalyst layers on both sides of the polymer electrolyte membrane, and the ETFE sheets are separated from the catalyst layers to obtain a membrane catalyst layer assembly having an electrode area of 25 cm².

On a gas diffusion layer made of carbon paper, a carbon layer comprising carbon and polytetrafluoroethylene is formed.

The membrane/catalyst layer assembly is sandwiched between such gas diffusion layers so that the carbon layer and the catalyst layer are in contact with each other, to obtain a membrane/electrode assembly.

The membrane/electrode assembly is assembled into a cell for power generation, and the power generation characteristics are evaluated. The results are shown in Table 2.

### (Ex. 2)

Into a stainless steel autoclave having an internal capacity of 230 mL, 42.89 g of compound (mb2-1), 11.40 g of compound (ma1-1), 41.01 g of compound (s-1) as a solvent and 28.8 mg of compound (i-1) as a radical polymerization initiator were charged, followed by sufficient deaeration under cooling with liquid nitrogen. The temperature was raised to 40° C., TFE was continuously supplied under a pressure of 0.16 MPaG at constant temperature and pressure. Every time 0.09 g of TFE was supplied, a mixture of 1.08 g of compound (mb2-1) and 1.50 g of compound (ma1-1) was supplied from a supply line cooled with dry ice. Further, every time the mixture was supplied, the supply line was washed with 1.0 g of compound (s-1). The mixture was supplied totally 11 times. The interval between supplies of the mixture was about 30 to 60 minutes. 9.4 hours after initiation of supply of TFE, the autoclave was cooled to terminate the reaction since the TFE supply amount reached a predetermined amount.

The formed product was diluted with compound (s-1), n-hexane was added thereto to agglomerate a polymer, followed by filtration. The polymer was stirred in compound (s-1) and re-agglomerated with n-hexane, followed by filtration. The polymer was dried under reduced pressure overnight at 80° C. to obtain 23.5 g of polymer (F-2). The ratio of units in polymer (F-2) was compound (mb2-1):compound (ma1-1):TFE=53:34:13 (mol %), and the ion exchange capacity of polymer (H-2) calculated from the ratio was 1.19 meq/g dry resin. TQ of polymer (F-2) was 275° C. In the same manner as in Ex. 1, polymer (H-2) formed by conversion of the —SO₃K groups to sulfonic acid groups, and liquid composition (D-2) having polymer (H-2) dispersed in a dispersion medium, were obtained. The water content of polymer (H-2) was 50%. The results are shown in Table 1.

A membrane/electrode assembly is prepared in the same manner as in Ex. 1 except that liquid composition (D-2) is used instead of liquid composition (D-1) used for forming the catalyst layers, and the power generation characteristics are evaluated. The results are shown in Table 2.

### (Ex. 3)

Into a stainless steel autoclave having an internal capacity of 230 mL, 45.68 g of compound (mb2-1), 15.0 g of compound (ma1-1), 45.01 g of compound (s-1) as a solvent and 105.8 mg of compound (i-1) as a radical polymerization initiator were charged, followed by sufficient deaeration under cooling with liquid nitrogen. The temperature was raised to 40° C., TFE was continuously supplied under a pressure of 0.11 MPaG at constant temperature and pressure. Every time 0.12 g of TFE was supplied, a mixture of 1.43 g of compound (mb2-1) and 2.00 g of compound (ma1-1) was supplied from a supply line cooled with dry ice. Further, every time the mixture was supplied, the supply line was washed with 1.5 g of compound (s-1). The mixture was supplied totally 11 times. The interval between supplies of the mixture was about 30 to 60 minutes. 7.4 hours after initiation of supply of TFE, the autoclave was cooled to terminate the reaction since the TFE supply amount reached a predetermined amount.

The formed product was diluted with compound (s-1), n-hexane was added thereto to agglomerate a polymer, followed by filtration. The polymer was stirred in compound (s-1) and re-agglomerated with n-hexane, followed by filtration. The polymer was dried under reduced pressure overnight at 80° C. to obtain 50.5 g of polymer (F-3). The ratio of units in polymer (F-3) was compound (mb2-1):compound (ma1-1):TFE=51:35:14 (mol %), and the ion exchange capacity of polymer (H-3) calculated from the ratio was 1.22 meq/g dry resin. TQ of polymer (F-3) was 280° C. In the same manner as in Ex. 1, polymer (H-3) formed by conversion of the —SO₃K groups to sulfonic acid groups, and liquid composition (D-3) having polymer (H-3) dispersed in a dispersion medium, were obtained. The water content of polymer (H-3) was 80%. The results are shown in Table 1.

A membrane/electrode assembly is prepared in the same manner as in Ex. 1 except that liquid composition (D-3) is used instead of liquid composition (D-1) used for forming the catalyst layers, and the power generation characteristics are evaluated. The results are shown in Table 2.

### (Ex. 4)

Into a stainless steel autoclave having an internal capacity of 125 mL, 19.69 g of compound (mb1-1), 7.3 g of compound (ma2-1), 17.2 g of compound (s-1) as a solvent and 44.2 mg of compound (i-1) as a radical polymerization initiator are charged, followed by sufficient deaeration under cooling with liquid nitrogen. The temperature is raised to 40° C., TFE is continuously supplied under a pressure of 0.8 MPaG at constant temperature and pressure. Every time 0.37 g of TFE is supplied, a mixture of 0.88 g of compound (mb1-1) and 1.0 g of compound (ma2-1) is supplied from a supply line cooled with dry ice. Further, every time the mixture is supplied, the supply line is washed with 1.5 g of compound (s-1). The mixture is supplied totally 9 times. The interval between supplies of the mixture is about 30 to 60 minutes. 6 hours after initiation of supply of TFE, the autoclave is cooled to terminate the reaction since the TFE supply amount reaches a predetermined amount.

The formed product is diluted with compound (s-1), n-hexane is added thereto to agglomerate a polymer, followed by filtration. The polymer is stirred in compound (s-1) and re-agglomerated with n-hexane, followed by filtration. The polymer is dried under reduced pressure overnight at 80° C. to obtain 20 g of polymer (F-4). The ratio of units in polymer (F-4) is compound (mb1-1):compound (ma2-1):TFE=24:40:36 (mol %), and the ion exchange capacity of polymer (H-4) calculated from the ratio is 1.09 meq/g dry resin. TQ of polymer (F-4) is 280° C. In the same manner as in Ex. 1, polymer (H-4) formed by conversion of the —SO₃K groups to sulfonic acid groups, and liquid composition (D-4) having polymer (H-4) dispersed in a dispersion medium, are obtained. The water content of polymer (H-4) is 90%. The results are shown in Table 3.

A membrane/electrode assembly is prepared in the same manner as in Ex. 1 except that liquid composition (D-4) is used instead of liquid composition (D-1) used for forming the catalyst layers, and the power generation characteristics are evaluated. The results are shown in Table 4.

### (Ex. 5)

Into a stainless steel autoclave having an internal capacity of 125 mL, 16.38 g of compound (mb2-1), 11.58 g of compound (ma1-1), 100 g of compound (s-1) as a solvent and 25.9 mg of compound (i-1) as a radical polymerization initiator were charged, followed by sufficient deaeration under cooling with liquid nitrogen. 5.5 g of TFE was charged, and the temperature was raised to 40° C., followed by stirring for 6.5 hours, and then the autoclave was cooled to terminate the reaction.

The formed product was diluted with compound (s-1), and n-hexane was added thereto to agglomerate a polymer, followed by filtration. The polymer was stirred in compound (s-1) and re-agglomerated with n-hexane, followed by filtration. The polymer was dried under reduced pressure overnight at 80° C. to obtain 14.4 g of polymer (F-5). The ratio of units in the polymer (F-5) was compound (mb2-1):compound (ma1-1):TFE=35:30:35 (mol %), and the ion exchange capacity of polymer (H-5) calculated from the ratio was 1.21 meq/g dry resin. TQ of polymer (F-5) was 253° C. In the same manner as in Ex. 1, polymer (H-5) formed by conversion of the —SO₃K groups to sulfonic acid groups, and liquid composition (D-5) having polymer (H-5) dispersed in a dispersion medium, were obtained. The water content of polymer (H-5) was 150%. The results are shown in Table 1.

A membrane/electrode assembly is prepared in the same manner as in Ex. 1 except that liquid composition (D-5) is used instead of liquid composition (D-1) used for forming the catalyst layers, and the power generation characteristics are evaluated. The evaluation results are shown in Table 2.

### (Ex. 6)

Into a stainless steel autoclave having an internal capacity of 125 mL, 35.39 g of compound (mb2-1), 23.32 g of compound (ma1-1), 20.0 g of compound (s-1) as a solvent and 39.7 mg of compound (i-1) as a radical polymerization initiator were charged, followed by sufficient deaeration under cooling with liquid nitrogen. 18.1 g of TFE was charged, and the temperature was raised to 40° C., followed by stirring for 2 hours, and then the autoclave was cooled to terminate the reaction.

The formed product was diluted with compound (s-1), and n-hexane was added thereto to agglomerate a polymer, followed by filtration. The polymer was stirred in compound (s-1) and re-agglomerated with n-hexane, followed by filtration. The polymer was dried under reduced pressure overnight at 80° C. to obtain 29.4 g of polymer (F-6). The ratio of units in the polymer (F-6) was compound (mb2-1):compound (ma1-1):TFE=27:27:46 (mol %), and the ion exchange capacity of polymer (H-6) calculated from the ratio was 1.19 meq/g dry resin. TQ of polymer (F-6) was 308° C. In the same manner as in Ex. 1, polymer (H-6) formed by conversion of the —SO₃K groups to sulfonic acid groups, and liquid composition (D-6) having polymer (H-6) dispersed in a dispersion medium, were obtained. The water content of polymer (H-6) was 170%. The results are shown in Table 1.

A membrane/electrode assembly is prepared in the same manner as in Ex. 1 except that liquid composition (D-6) is used instead of liquid composition (D-1) used for forming the catalyst layers, and the power generation characteristics are evaluated. The evaluation results are shown in Table 2.

### (Ex. 7)

A replication study of Ex. 8 in Patent Document 1 is carried out to define the water content of polymer (H) in Ex. 8 of Patent Document 1.

Into a stainless steel autoclave having an internal capacity of 125 mL, 15.25 g of compound (mb2-1), 22.26 g of compound (ma1-1), 11.0 g of compound (s-1) as a solvent and 24 mg of compound (i-2) as a radical polymerization initiator are charged, followed by sufficient deaeration under cooling with liquid nitrogen. 3.0 g of TFE is charged, and the temperature is raised to 65° C., followed by stirring for 18 hours, and the autoclave is cooled to terminate the reaction.

The formed product is diluted with compound (s-1), and n-hexane is added thereto to agglomerate a polymer, followed by filtration. The polymer is stirred in compound (s-1) and re-agglomerated with n-hexane, followed by filtration. The polymer is dried under reduced pressure overnight at 80° C. to obtain 15.0 g of polymer (F-7). The ratio of units in polymer (F-7) is compound (mb2-1):compound (ma1-1):TFE=26:60:14 (mol %), and the ion exchange capacity of polymer (H-7) calculated from the ratio is 1.81 meq/g dry resin. TQ of polymer (F-7) is 280° C. In the same manner as in Ex. 1, polymer (H-7) formed by conversion of the —SO₃K groups to sulfonic acid groups, and liquid composition (D-7) having polymer (H-7) dispersed in a dispersion medium, are obtained. The water content of polymer (H-7) is 510%. The results are shown in Table 1.

A membrane/electrode assembly is prepared in the same manner as in Ex. 1 except that liquid composition (D-7) is used instead of liquid composition (D-1) for forming the catalyst layers, and the power generation characteristics are evaluated. The evaluation results are shown in Table 2.

### (Ex. 8)

A replication study of Ex. 9 in Patent Document 1 is carried out to define the water content of the polymer (H) in Ex. 9 of Patent Document 1.

Into a stainless steel autoclave having an internal capacity of 125 mL, 21.96 g of compound (mb2-1), 21.2 g of compound (ma1-1), 13.0 g of compound (s-1) as a solvent and 25 mg of compound (i-1) as a radical polymerization initiator are charged, followed by sufficient deaeration under cooling with liquid nitrogen. 4.25 g of TFE is charged, and the temperature is raised to 65° C., followed by stirring for 18 hours, and the autoclave is cooled to terminate the reaction.

The formed product is diluted with compound (s-1), and n-hexane is added thereto to agglomerate a polymer, followed by filtration. The polymer is stirred in compound (s-1) and re-agglomerated with n-hexane, followed by filtration. The polymer is dried under reduced pressure overnight at 80° C. to obtain 17.0 g of polymer (F-8). The ratio of units in polymer (F-8) is compound (mb2-1):compound (ma1-1):TFE=34:50:16 (mol %), and the ion exchange capacity of polymer (H-8) calculated from the ratio is 1.61 meq/g dry resin. TQ of polymer (F-8) is 280° C. In the same manner as in Ex. 1, polymer (H-8) formed by conversion of the —SO₃K groups to sulfonic acid groups, and liquid composition (D-8) having polymer (H-8) dispersed in a dispersion medium, are obtained. The water content of polymer (H-8) is 240%.

A membrane/electrode assembly is prepared in the same manner as in Ex. 1 except that liquid composition (D-8) is used instead of liquid composition (D-1) for forming the catalyst layers, and the power generation characteristics are evaluated. The evaluation results are shown in Table 2.

### (Ex. 9)

Into a stainless steel autoclave having an internal capacity of 125 mL, 17.9 g of compound (mb1-1), 9.8 g of compound (ma2-1), 17.2 g of compound (s-1) as a solvent and 44.9 mg of compound (i-1) as a radical polymerization initiator are charged, followed by sufficient deaeration under cooling with liquid nitrogen. 1.0 g of TFE is charged, and the temperature is raised to 40° C., followed by stirring for 7 hours, and the autoclave is cooled to terminate the reaction.

The formed product is diluted with compound (s-1), and n-hexane is added thereto to agglomerate a polymer, followed by filtration. The polymer is stirred in compound (s-1) and re-agglomerated with n-hexane, followed by filtration. The polymer is dried under reduced pressure overnight at 80° C. to obtain 20 g of polymer (F-9). The ratio of units in polymer (F-9) is compound (mb1-1):compound (ma2-1):TFE=28:50:22 (mol %), and the ion exchange capacity of polymer (H-9) calculated from the ratio is 1.15 meq/g dry resin. TQ of polymer (F-9) is 280° C. In the same manner as in Ex. 1, polymer (H-9) formed by conversion of the —SO₃K groups to sulfonic acid groups, and liquid composition (D-9) having polymer (H-9) dispersed in a dispersion medium, are obtained. The water content of polymer (H-9) is 140%. The results are shown in Table 3.

A membrane/electrode assembly is prepared in the same manner as in Ex. 1 except that liquid composition (D-9) is used instead of liquid composition (D-1) for forming the catalyst layers, and the power generation characteristics are evaluated.

The evaluation results are shown in Table 4.

TABLE 1

| | Supply method | | Polymer (F) | | | | Polymer (H) | |
|---|---|---|---|---|---|---|---|---|
| | (ma) | | (mb2-1) | (ma1-1) | TFE | TQ | Ion exchange | Water |
| Ex. | (mb) | TFE | (mol %) | (mol %) | (mol %) | (° C.) | capacity (meq/g) | content (%) |
| 1 | Intermittent | Continuous | 52 | 31 | 17 | 289 | 1.13 | 35 |
| 2 | Intermittent | Continuous | 53 | 34 | 13 | 275 | 1.19 | 50 |
| 3 | Intermittent | Continuous | 51 | 35 | 14 | 280 | 1.22 | 80 |
| 5 | All at once | All at once | 35 | 30 | 35 | 253 | 1.21 | 150 |
| 6 | All at once | All at once | 27 | 27 | 46 | 308 | 1.19 | 170 |
| 7 | All at once | All at once | 26 | 60 | 14 | 280 | 1.81 | 510 |
| 8 | All at once | All at once | 34 | 50 | 16 | 280 | 1.61 | 240 |

TABLE 2

| | | Power generation |
|---|---|---|
| Ex. | Liquid composition | characteristics |
| 1 | D-1 | ◯ |
| 2 | D-2 | ◯ |
| 3 | D-3 | ◯ |
| 5 | D-5 | X |
| 6 | D-6 | X |
| 7 | D-7 | X |
| 8 | D-8 | X |

TABLE 3

| | | | | | | | Polymer (H) | |
|---|---|---|---|---|---|---|---|---|
| | | | Polymer (F) | | | | Ion | |
| | Supply method | | (mb1- | (ma2- | | | exchange | Water |
| | (ma) | | 1) | 1) | TFE | TQ | capacity | content |
| Ex. | (mb) | TFE | (mol %) | (mol %) | (mol %) | (° C.) | (meq/g) | (%) |
| 4 | Intermittent | Continuous | 24 | 40 | 36 | 280 | 1.09 | 90 |
| 9 | All at once | All at once | 28 | 50 | 22 | 280 | 1.15 | 140 |

TABLE 4

| | | Power generation |
|---|---|---|
| Ex. | Liquid composition | characteristics |
| 4 | D-4 | ◯ |
| 9 | D-9 | X |

### INDUSTRIAL APPLICABILITY

The electrolyte material of the present invention is useful as an electrolyte material for a polymer electrolyte fuel cell. Further, it is also useful for other applications (such as a proton permselective membrane to be used for water electrolysis, hydrogen peroxide production, ozone production or waste acid recovery; a diaphragm for electrolysis of sodium chloride or a redox flow cell, or a cation exchange membrane for electrodialysis to be used for desalination or salt production.

This application is a continuation of PCT Application No. PCT/JP2014/060750, filed on Apr. 15, 2014, which is based upon and claims the benefit of priority from Japanese Patent Application No. 2013-089797 filed on Apr. 22, 2013. The contents of those applications are incorporated herein by reference in their entireties.

### REFERENCE SYMBOLS

10: Membrane/electrode assembly
11: Catalyst layer
12: Gas diffusion layer
13: Anode
14: Cathode
15: Polymer electrolyte membrane
16: Carbon layer

What is claimed is:

1. An electrolyte material, which is formed of a polymer (H) obtained by converting —SO₂F groups in the following polymer (F) to ion exchange groups, which has an ion exchange capacity of from 0.9 to 1.3 meq/g dry resin, and which has a water content measured by the following method of from 20 to 100%:
Polymer (F):
a copolymer having at least one type of units (A) selected from the group consisting of units (A1) derived form a compound represented by the following formula (ma1) and units (A2) derived form a compound represented by the following formula (ma2),
at least one type of units (B) selected from the group consisting of units (B1) derived form a compound represented by the following formula (mb1) and units (B2) derived form a compound represented by the following formula (mb2), and
units (C) derived from tetrafluoroethylene, and
having at least one type of units selected from the group consisting of the units (A1) derived from a compound represented by the following formula (ma1) and the units (B1) derived from a compound represented by the following formula (mb1): 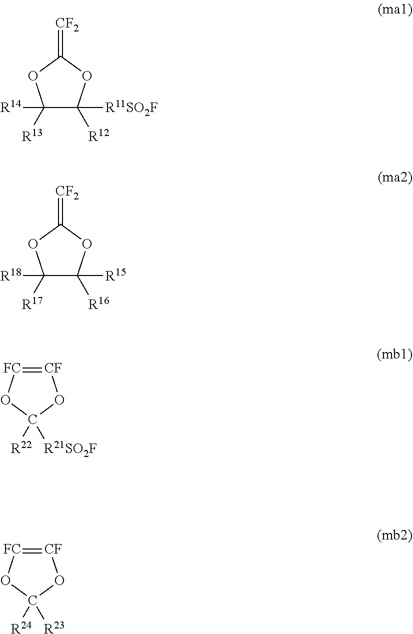
wherein R¹¹ is a C₁₋₁₀ perfluoroalkylene group or a C₂₋₁₀ perfluoroalkylene group having an etheric oxygen atom in a carbon-carbon bond,
each of R¹², R¹³ and R¹⁵ to R¹⁸ which are independent of one another, is a fluorine atom, a C₁₋₁₀ perfluoroalkyl group or a C₂₋₁₀ perfluoroalkyl group having an etheric oxygen atom in a carbon-carbon bond,
R¹⁴ is a fluorine atom, a C₁₋₁₀ perfluoroalkyl group, a C₂₋₁₀ perfluoroalkyl group having an etheric oxygen atom in a carbon-carbon bond, or a —R¹¹SO₂F group,
R²¹ is a C₁₋₁₀ perfluoroalkylene group or a C₂₋₁₀ perfluoroalkylene group having an etheric oxygen atom in a carbon-carbon bond,
R²² is a fluorine atom, a C₁₋₁₀ perfluoroalkyl group, a C₂₋₁₀ perfluoroalkyl group having an etheric oxygen atom in a carbon-carbon bond, or a —R²¹SO₂F group, and
each of R²³ and R²⁴ which are independent of each other, is a fluorine atom, a C₁₋₁₀ perfluoroalkyl group or a C₂₋₁₀ perfluoroalkyl group having an etheric oxygen atom in a carbon-carbon bond:
Method for measuring water content: A film of the polymer (H) is dipped in warm water at 80° C. for 16 hours, the film together with the warm water is cooled to room temperature. The film is taken out from the water, water droplets attached to the surface are wiped off and immediately after wiping, the mass W1 of the film containing water is measured. The film is put in a globe box and left to stand in an atmosphere into which dry nitrogen is blown for 24 hours or longer to dry the film. The dry mass W2 of the film is measured in the globe box. The water content is obtained from the following formula (1):
Water content (%)=(W1−W2)/W2×100 (1)

2. The electrolyte material according to claim 1, wherein the sum of the units (A) and the units (B) is from 30 to 90 mol % based on all the monomer units (100 mol %).

3. The electrolyte material according to claim 1, wherein the compound represented by the formula (ma1) is a compound of the following formula (ma1-1), the compound represented by the formula (ma2) is a compound of the following formula (ma2-1), the compound represented by the formula (mb1) is a compound of the following formula (mb1-1), and the compound represented by the formula (mb2) is a compound of the following formula (mb2-1):

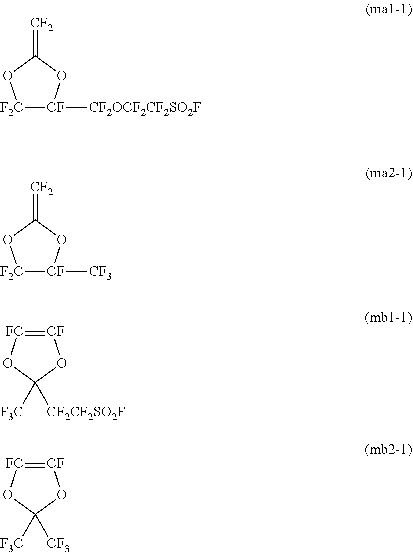

4. The electrolyte material according to claim 1, wherein the polymer (F) is one obtained by the following method:
Method for producing polymer (F): In a polymerization container, at least one compound (ma) selected from the group consisting of a compound represented by the above formula (ma1) and a compound represented by the above formula (ma2), at least one compound (mb) selected from the group consisting of a compound represented by the above formula (mb1) and a compound represented by the above formula (mb2), and tetrafluoroethylene, are continuously or intermittently supplied over a period of at least 2 hours, particularly from 2 to 15 hours and copolymerized (provided that at least one compound to be supplied to the polymerization container is a compound selected from the group consisting of the compound represented by the formula (ma1) and the compound represented by the formula (mb1).

5. A process for producing an electrolyte material, which comprises the following steps (a) and (b):
(a) a step of continuously or intermittently supplying to a polymerization container at least one compound (ma) selected from the group consisting of a compound represented by the following formula (ma1) and a compound represented by the following formula (ma2), at least one compound (mb) selected from the group consisting of a compound represented by the following formula (mb1) and a compound represented by the following formula (mb2), and tetrafluoroethylene, over a period of at least 2 hours, particularly from 2 to 15 hours to copolymerize them thereby to obtain a polymer (F) having —SO₂F groups (provided that at least one compound to be supplied to the polymerization container is a compound selected from the group consisting of the compound represented by the following formula (ma1) and the compound represented by the following formula (mb1); and
(b) a step of converting —SO₂F groups in the polymer (F) to ion exchange groups to obtain an electrolyte material formed of a polymer (H) having ion exchange groups: 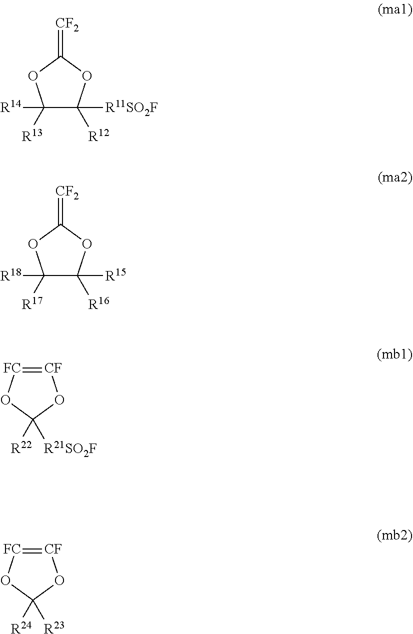
wherein R¹¹ is a C₁₋₁₀ perfluoroalkylene group or a C₂₋₁₀ perfluoroalkylene group having an etheric oxygen atom in a carbon-carbon bond,
each of R¹², R¹³ and R¹⁵ to R¹⁸ which are independent of one another, is a fluorine atom, a C₁₋₁₀ perfluoroalkyl group or a C₂₋₁₀ perfluoroalkyl group having an etheric oxygen atom in a carbon-carbon bond,
R¹⁴ is a fluorine atom, a C₁₋₁₀ perfluoroalkyl group, a C₂₋₁₀ perfluoroalkyl group having an etheric oxygen atom in a carbon-carbon bond, or a —R¹¹SO₂F group,
R²¹ is a C₁₋₁₀ perfluoroalkylene group or a C₂₋₁₀ perfluoroalkylene group having an etheric oxygen atom in a carbon-carbon bond,
R²² is a fluorine atom, a C₁₋₁₀ perfluoroalkyl group, a C₂₋₁₀ perfluoroalkyl group having an etheric oxygen atom in a carbon-carbon bond, or a —R²¹SO₂F group, and
each of R²³ and R²⁴ which are independent of each other, is a fluorine atom, a C₁₋₁₀ perfluoroalkyl group or a C₂₋₁₀ perfluoroalkyl group having an etheric oxygen atom in a carbon-carbon bond.

6. The process for producing an electrolyte material according to claim 5, wherein the sum of the compound (ma) and the compound (mb) is from 30 to 90 mol % based on all the monomers (100 mol %).

7. The process for producing an electrolyte material according to claim 5, wherein the compound represented by the formula (ma1) is a compound of the following formula (ma1-1), the compound represented by the formula (ma2) is a compound of the following formula (ma2-1), the compound represented by the formula (mb1) is a compound of the following formula (mb1-1), and the compound represented by the formula (mb2) is a compound of the following formula (mb2-1):

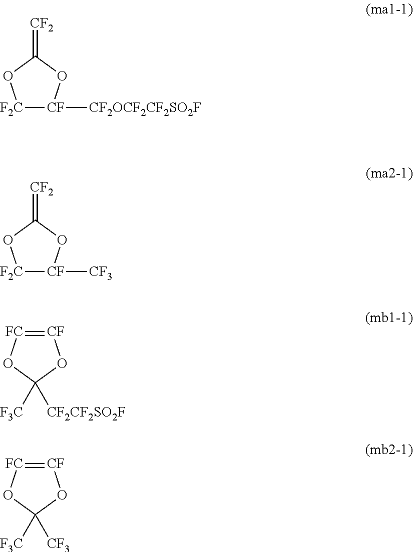

8. The process for producing an electrolyte material according to claim 5, wherein the compound (ma) and the compound (mb) are supplied with cooling.

9. A liquid composition comprising a dispersion medium and the electrolyte material as defined in claim 1 dispersed in the dispersion medium, wherein the dispersion medium contains an organic solvent having a hydroxy group.

10. A membrane/electrode assembly for a polymer electrolyte fuel cell, which comprises
an anode having a catalyst layer,
a cathode having a catalyst layer, and
a polymer electrolyte membrane disposed between the anode and the cathode,
wherein at least one of the cathode and the anode contains the electrolyte material as defined in claim 1.
